(19) United States
(12) Patent Application Publication
(10) Pub. No.: US 2013/0319157 A1
(43) Pub. Date: Dec. 5, 2013

(54) PARALLEL-TYPE MANIPULATOR

(71) Applicant: Guk Jin Yang, Yongin-si (KR)

(72) Inventor: Guk Jin Yang, Yongin-si (KR)

(21) Appl. No.: 13/812,852

(22) PCT Filed: Jun. 4, 2012
(86) PCT No.: PCT/KR2012/004349

§ 371 Date: Aug. 23, 2013

(30) Foreign Application Priority Data
Jun. 7, 2011 (KR) 10-2011-0054463

(51) Int. Cl. B25J 18/00

(52) U.S. Cl. CPC B25J 18/00; Y10S 901/27
USPC 74/490.03; 901/23; 901/27

(57) ABSTRACT

A parallel manipulator is provided. The parallel manipulator includes a base plate, a plurality of motor devices coupled to the base plate, arm modules coupled respectively to the plurality of motor devices, and a support member hinged to ends of the arm modules. Here, the motor device includes a motor and a gear module coupled to the motor, and each of the arm modules includes an elastic arm unit coupled to the gear module to absorb an external force so as to prevent a step-out error from taking place in the gear module, an upper arm unit hinged to the base plate and having the elastic arm unit hinged to one end thereof, and a lower arm unit having the other end of the upper arm unit hinged to one end thereof and the support member hinged to the other end thereof

### CROSS-REFERENCE TO RELATED APPLICATION

This application is a National Stage Application under 35 U.S.C. §371 of PCT Application No. PCT/KR2012/004349, filed Jun. 4, 2012, which claims priority of Korean Patent Application No. 2011-0054463, filed Jun. 7, 2011, the entire contents of which are hereby incorporated by reference.

### BACKGROUND

1. Field of the Invention

The present invention relates to a parallel manipulator, and, more particularly, to a device which is widely used in the field of industrial applications and is able to transfer an object with spatial precision.

2. Discussion of Related Art

A parallel manipulator is an apparatus that is used in precision industry such as semiconductor industry, electronic parts, etc. In general, the parallel manipulator serves to transfer an object from space A to space B at a high speed. Also, the parallel manipulator includes a plurality of robot arms and support units attached to ends of the plurality of robot arms. Here, an object may be transferred using the support units. A motor is coupled to each of the plurality of robot arms, and a reduction gear module is coupled to the motor.

In the field of precision industry, a degree of precision is to determine the qualities of the parallel manipulator. An object should be transferred to an exact position without an error of 1 mm, depending on a signal transferred to a control unit. However, a parallel manipulator which operates mechanically regardless of the signal transferred to the control unit serves to move an object with a slight error.

For example, when an input signal, which instructs a reduction gear module to move forward by 5 mm and move backward by 5 mm immediately after the forward movement, is provided, the reduction gear module is substantially allowed to move forward by 5 and move backward by approximately 4.9 mm. This is because a step-out error takes place in the reduction gear module of the motor. In general, gears of the reduction gear module are engaged with each other. In this case, the gears are engaged so that they can be spaced apart at a suitable gap due to an error caused during a process or an assembly. When an excessive load is applied to the rotation axes of the gears, the gears are idling without being exactly engaged with each other. This idling of the gears prevents the parallel manipulator from transferring an object to an exact position corresponding to a given signal.

This step-out error may be caused due to a sudden change in direction. A motor composed of precision-processed gears may be used to remove the step-out error. However, such a motor is very expensive.

Therefore, there is an increasing demand for a parallel manipulator capable of removing a step-out error without a structural change of the motor.

### SUMMARY OF THE INVENTION

The present invention is designed to solve the problems of the prior art, and therefore it is an object of the present invention to provide a parallel manipulator capable of preventing a step-out error from taking place even when an object is suddenly allowed to move forward, backward, left and right.

It is another object of the present invention to provide a parallel manipulator capable of removing a step-out error without using an expensive motor device.

One aspect of the present invention provides a parallel manipulator including a base plate, a plurality of motor devices coupled to the base plate, arm modules coupled respectively to the plurality of motor devices, and a support member hinged to the arm modules. Here, the motor device includes a motor and a gear module coupled to the motor, and each of the arm modules includes an elastic arm unit coupled to the gear module to absorb an external force so as to prevent a step-out error from taking place in the gear module, an upper arm unit hinged to the base plate and having the elastic arm unit hinged to one end thereof, and a lower arm unit having the other end of the upper arm unit hinged to one end thereof and the support member hinged to the other end thereof.

In this case, the elastic arm unit may be a leaf spring.

### BRIEF DESCRIPTION OF THE DRAWINGS

The above and other objects, features and advantages of the present invention will become more apparent to those of ordinary skill in the art by describing in detail exemplary embodiments thereof with reference to the attached drawing, in which:

FIG. 1 is a perspective view showing a parallel manipulator according to one exemplary embodiment of the present invention.

### DETAILED DESCRIPTION OF EXEMPLARY EMBODIMENTS

Example embodiments of the present invention are described below in sufficient detail to enable those of ordinary skill in the art to embody and practice the present invention. It is important to understand that the present invention may be embodied in many alternate foams and should not be construed as limited to the example embodiments set forth herein.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof

With reference to the appended drawings, exemplary embodiments of the present invention will be described in detail below. To aid in understanding the present invention, like numbers refer to like elements throughout the description of the figures, and the description of the same elements will be not reiterated.

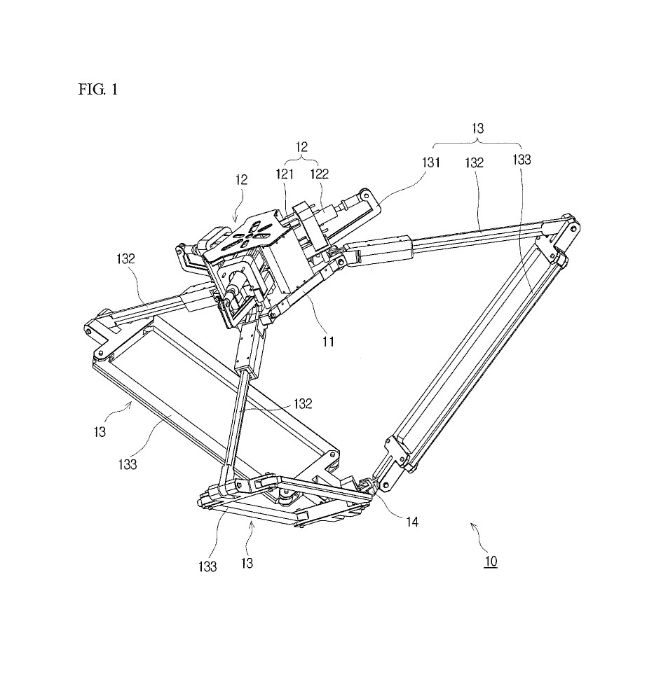

FIG. 1 is a perspective view showing a parallel manipulator according to one exemplary embodiment of the present invention.

The parallel manipulator 10 according to one exemplary embodiment of the present invention includes a base plate 11, a plurality of motor devices 12 coupled to the base plate 11, arm modules 13 coupled respectively to the plurality of motor devices 12, and a support member 14 hinged to the arm modules 13. Here, the motor device 12 includes a motor 121 and a gear module 122 coupled to the motor, and each of the arm modules 13 includes an elastic arm unit 131 coupled to the gear module 122, an upper arm unit 132 hinged to the base plate 11 and having the elastic arm unit 131 hinged to one end thereof, and a lower arm unit 133 having the other end of the upper arm unit 132 hinged to one end thereof and the support member 14 hinged to the other end thereof.

The parallel manipulator 10 according to one exemplary embodiment of the present invention is an apparatus that enables a precise motion without a step-out error.

In general, the parallel manipulator includes three arm modules. Therefore, the parallel manipulator 10 including the three arm modules is provided according to one exemplary embodiment of the present invention. However, the technical principle according to one exemplary embodiment of the present invention may also be applied to a parallel manipulator including at least two arm modules.

The three motor devices 12 are coupled to the base plate 11. The three motor devices 12 may be disposed at an equal angle with respect to the center of the base plate 11. Each of the motor devices 12 is configured to include a motor 121 and a gear module 122. The motor devices 12 are disposed so that the rotation axes of the motor devices 12 can face the outside of the base plate 11, and the gear modules 122 are also disposed so that the gear modules 122 can face the outside of the base plate 11. Each of the gear modules 122 has gears engagingly installed therein to convert a rotary motion into a rectilineal motion. Also, each of the gear modules 122 is composed of a combination of reduction gears.

An arm module 13 is coupled to each of the motor devices 12, and thus three arm modules 13 may be provided. The arm modules 13 have the same configuration.

The elastic arm unit 131 is coupled to each of the gear modules 122.

The elastic arm unit 131 may be configured as a leaf spring. The elastic arm unit 131 has a sufficient modulus of elasticity to prevent shrinkage or expansion when the arm modules 13 work normally. When the strong resistance which is sufficient to cause a step-out error in the gear module 122 is applied to the upper arm unit 132, however, the upper arm unit 132 may be changed in shape (for example, a leaf spring may be bended), thereby lowering the resistance.

The upper aim unit 132 is hinged to the base plate 11, and one end of the upper arm unit 132 is hinged to the elastic arm unit 132.

One end of the lower arm unit 133 is hinged to the other end of the upper arm unit 132, and the other end of the lower arm unit 133 is hinged to the support member 14.

The three lower arm units 133 are hinged to the support member 14. The support member 14 may move in various modes within a space having a range of motion, depending on the types of motion of the three lower arm units 133. An additional apparatus that can hold an object, such as a vacuum pumping system, may be coupled to the support member 14.

Since the upper arm unit 132, the lower arm unit 133 and the support member 14 are shown in the parallel manipulator known in the related art, detailed descriptions thereof are omitted for clarity. According to one exemplary embodiment of the present invention, how for the elastic aim unit 131 to remove a step-out error will be described in further detail.

A step-out error takes place in the gear module 122 when a resistance is suddenly formed in the rotation axis. In general, the step-out error does not take place when the parallel manipulator 10 is slowly driven to transfer an object. Even when the parallel manipulator 10 is allowed to transfer an object while being in a stop state, no step-out error takes place. The gear modules 122 widely used in the parallel manipulator 10 are designed to prevent a step-out error from taking place therein.

However, when an operation of transferring an object from space A to space B at a high speed is repeatedly performed in a continuous manner, a strong force is required to turn a direction of motion at a turning point of a reciprocating motion (for example, a point in which a motion from space B to space A is suddenly carried out after a motion from space A to space B is carried out). To turn a direction of motion at the turning point, a strong torque of the motor 121 is required. The gears of the gear module 122 are not engaged due to such a strong torque (i.e., a turning force), thereby causing idling of the gears. This is a step-out error. As a result, even when the gears are not engaged once or two times, an object cannot be readily transferred to an exact position.

Therefore, a buffer member configured to compensate for a torque generated in the motor 121 is required before the motor 121 provides a sufficient turning force to cause a step-out error. According to one exemplary embodiment of the present invention, when the elastic arm unit 131 is instantly driven to transfer a turning force at which a step-out error may be caused in the motor 121, the step-out error is instantly lowered.

For example, a step-out error is not caused when a turning force of 100 is applied to the gear module 122 (wherein the number “100” is merely referred to any relative numeral for the purpose of illustrative description). In this case, there is no change in shape of the elastic arm unit 131. As a result, all the turning force of 100 may be buffered in the gear module 122.

However, when a turning force of 120 is transferred from the motor 121, an instant change in shape of the elastic arm unit 131 is caused to absorb a turning force of approximately 20. Since a turning force of approximately 100 is transferred to the gear module 122, a step-out error is not caused as well.

To manufacture the parallel manipulator 10 according to one exemplary embodiment of the present invention, it is necessary to confirm whether a turning force at which the step-out error may take place amounts to a desired level. Then, when a turning force at which a step-out error is about to take place is formed, the elastic arm unit 131 is configured to be able to absorb the turning force. The elastic arm unit 131 may be configured in the form of a leaf spring. In this case, a plurality of leaf springs may be used in an overlapping manner.

According to one exemplary embodiment of the present invention, the elastic aim unit 131 capable of absorbing an impact has been used to remove the step-out error, as described above. A gear module having an elaborate engagement configuration has been used in the related art, which leads to an increase in manufacturing cost of the parallel manipulator. According to one exemplary embodiment of the present invention, however, the step-out error may be simply removed by further installing the elastic arm unit 131. As a result, the parallel manipulator may be manufactured at a relatively low cost.

As described above, the present invention provides a parallel manipulator capable of preventing a step-out error from taking place even when an object is suddenly allowed to move forward, backward, left and right.

Also, the present invention provides a parallel manipulator capable of removing the step-out error without using an expensive motor device.

While the invention has been shown and described with reference to certain exemplary embodiments thereof, it will be understood by those skilled in the art that various changes in form and details may be made therein without departing from the scope of the invention as defined by the appended claims.

What is claimed is:

1. A parallel manipulator comprising:
a base plate;
a plurality of motor devices coupled to the base plate;
arm modules coupled respectively to the plurality of motor devices;
a support member hinged to ends of the arm modules,
wherein the motor device comprises:
a motor; and
a gear module coupled to the motor, and
each of the arm modules comprises:
an elastic arm unit coupled to the gear module to absorb an external force so as to prevent a step-out error from taking place in the gear module;
an upper arm unit hinged to the base plate and having the elastic arm unit hinged to one end thereof; and
a lower arm unit having the other end of the upper arm unit hinged to one end thereof and the support member hinged to the other end thereof.

2. The parallel manipulator according to claim 1, wherein the elastic arm unit is a leaf spring.
